(19) United States
(12) Patent Application Publication
(10) Pub. No.: US 2012/0226846 A1
(43) Pub. Date: Sep. 6, 2012

(54) HDMI DEVICE AND ASSOCIATED POWER MANAGEMENT METHOD

(75) Inventor: Kuo-Chan CHUNG, Kaohsiung City (TW)

(73) Assignee: Realtek Semiconductor Corp., Hsinchu (TW)

(21) Appl. No.: 13/408,031

(22) Filed: Feb. 29, 2012

(30) Foreign Application Priority Data
Mar. 3, 2011 (TW) 100107025

(51) Int. Cl. G06F 13/14; G06F 1/26

(52) U.S. Cl. 710/305; 713/310

(57) ABSTRACT

An HDMI device and an associated power management method are provided for use in the case with an HDMI Ethernet Channel implemented. The HDMI device can acquire an external power source by connecting to another HDMI device through an HDMI interface. Thus, when the internal power source of the HDMI device is disabled, the external power source can be used as a backup power source for the internal Ethernet circuit of the HDMI device.

This application claims the benefit of Taiwan Patent Application Serial No. 100107025, filed on Mar. 3, 2011, the subject matter of which is incorporated herein by reference.

### BACKGROUND OF INVENTION

1. Field of the Invention

The invention relates to a high-definition multimedia interface (HDMI), and more particularly to an HDMI apparatus and its associated power management method for supporting an HDMI Ethernet channel.

2. Description of the Prior Art

In the HDMI 1.4 specification, cable functions for supporting the Ethernet are included. Since then, the HDMI apparatus can carry out high speed data transmission through the HDMI Ethernet channel (HDC) built-in the HDMI. In one specific application, an HDMI sink (TV for example) can ride an Ethernet interface to reach a WAN or a LAN, and the accompanying HDMI source (Network attached storage, NAS, for example) can also reach the same WAN or the same LAN through the Ethernet interface for performing data transmission, a video download for example. Upon such arrangement, in the case that plural HDMI apparatuses function at the same time, a whole WAN or LAN network connection or sharing for all can be simply achieved by having one of the apparatuses connected with the WAN or LAN network. Apparently, by introducing the aforementioned

HDMI technique, loudly cabling for integrating a plural-device network has been greatly simplified.

Nevertheless, in the aforementioned application, if an unexpected power shutdown or switch-off happens to the HDMI apparatus who is in charge of the connection with the WAN/LAN, then the shared networking among the HDMI apparatuses breaks and disconnection with the WAN/LAN for all the other HDMI apparatuses would be met. Apparently, such a consequence would cause problems for those apparatuses who need to work on long-term data-transmission, such as a video data download.

### SUMMARY OF THE INVENTION

Accordingly, it is the primary object of the present invention to provide an HDMI device and an associated power management method for an HDMI Ethernet channels. The HDMI device can utilize an HDMI interface to establish a connection with another HDMI device and thereby to obtain an external power source through the intern HDMI device. Upon such an arrangement, the HDMI device can still power the internal Ethernet no matter whether the HDMI device is on or off.

In one embodiment of the present invention, the HDMI device includes an HDMI interface having an HDMI Ethernet channel and an Ethernet circuit for energizing the HDMI Ethernet channel. The Ethernet circuit is powered externally by another HDMI device via the HDMI interface.

In one embodiment of the present invention, the power management method for an HDMI device having an HDMI interface, an internal power source and an Ethernet circuit is introduced. The HDMI interface of the HDMI device further has an Ethernet channel. The power management method includes the steps of: obtaining an external power from another HDMI device via the HDMI interface, and providing one of the external power or an internal power of the internal power source to the Ethernet circuit.

All these objects are achieved by the HDMI device and the associated power management method described below.

### BRIEF DESCRIPTION OF THE DRAWINGS

The present invention will now be specified with reference to its preferred embodiment illustrated in the drawings, in which:

FIG. 1 is a block diagram of an embodiment of the HDMI device in accordance with the present invention;

FIG. 2 is a block diagram of another embodiment (preferred) of the HDMI device in accordance with the present invention;

FIG. 3 is a block diagram of a further embodiment of the HDMI device in accordance with the present invention; and

FIG. 4 is a flowchart of an embodiment of the power management method in accordance with the present invention.

### DESCRIPTION OF THE PREFERRED EMBODIMENT

The invention disclosed herein is directed to an HDMI device and an associated power management method for the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

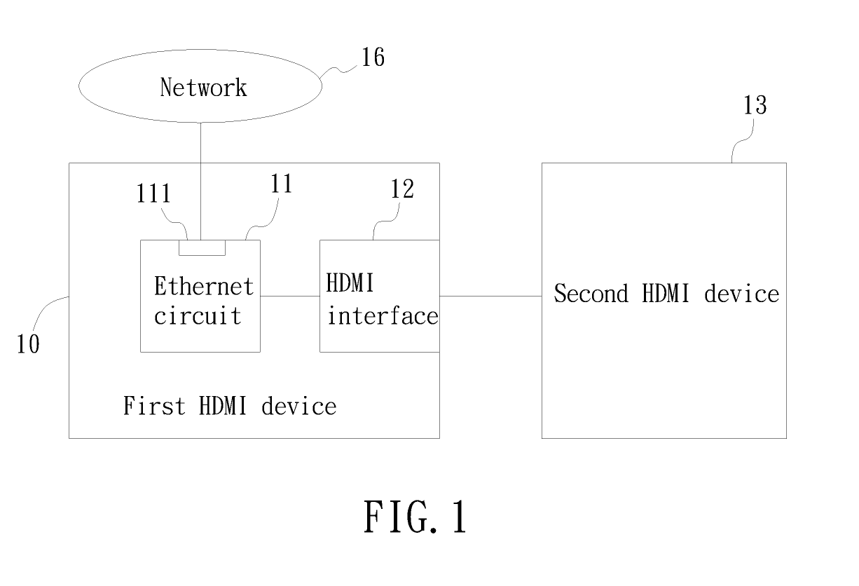

Referring now to FIG. 1, an embodiment of the HDMI device (the first HDMI device 10) is illustrated in a block diagram. As shown, the first HDMI device 10 can be embodied as any of various HDMI receiving devices, such as TVs, monitors and so on. The second HDMI device 13 can be any of various HDMI source devices, such as DVD players, digital set-top boxes, computers, network-attached storages, and so on. Also, in a further application, either the first HDMI device 10 or the second HDMI device 13 can be any device that includes an HDMI interface, such as an HDMI extender, an HDMI repeater, an HDMI multiplexer, and so on. As shown in FIG. 1, the first HDMI device 10 of this application includes an Ethernet circuit 11 and an HDMI interface 12. The HDMI interface 12 further comprises an HDMI Ethernet channel to couple with the Ethernet circuit 11. For example, the HDMI interface 12 can have an existing hot-plug port being applied as the HDMI Ethernet channel. Thereby, the second HDMI device 13 can be cabled to the network 16 via the HDMI interface 12, the Ethernet circuit 12 and the Ethernet interface 111. Upon such an arrangement, the first HDMI device 10 can obtain external power for the internal Ethernet circuit 11 from the second HDMI device 13 via the HDMI cable in between. In application, the second HDMI device 13 can send the power to the Ethernet circuit 11 via a source port (5V port for example) of the HDMI interface 12. Thereupon, even facing an OFF state at its own AC power source, the first HDMI device 10 can still obtain the required power through the HDMI interface 12 to operate normally the Ethernet circuit 11. Equally importantly, at this time, the second HDMI device 13 can still ride the Ethernet circuit 11 to perform data transmission with the network 16 via the HDMI Ethernet channel provided by the HDMI interface 12.

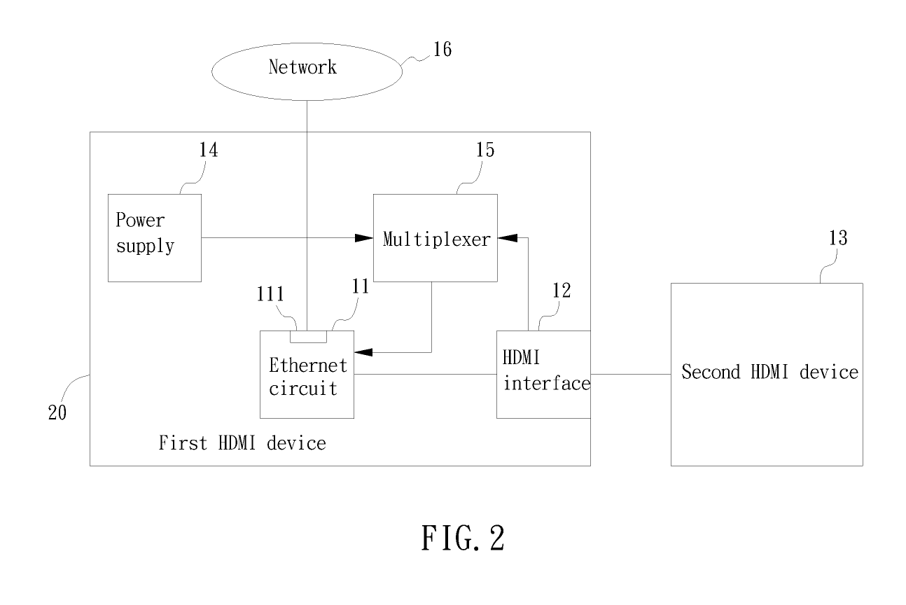

Referring now to FIG. 2, another embodiment (preferable) of the first HDMI device 20 in accordance with the present invention is illustrated in a block diagram. As shown, by compared to FIG. 1, the first HDMI device 20 further comprises a power supply 14 and a multiplexer 15. The power supply 14 is to provide an internal power source. The multiplexer 15 coupled with the power supply 14, the HDMI interface 12 and the Ethernet circuit 11 is to output power to the Ethernet circuit 11 from either the internal power source (i.e. the power supply 14) or the external power source (i.e. that from the second HDMI device 13). Upon such an arrangement, power management in the first HDMI device 20 can be much flexible, and thus normal operation in the Ethernet circuit 11 can be better assured. For instance, while the power supply 14 (the internal power source) is on, the multiplexer 15 can output the internal power to the Ethernet circuit 11. On the other hand, while the power supply 14 is off, the multiplexer 15 can still maintain the normal operation of the Ethernet circuit 11 by outputting the external power (as a backup power) to the Ethernet circuit 11.

In the aforementioned two embodiments shown in FIG. 1 and FIG. 2, the Ethernet circuit 11 can execute functions of Ethernet switching. For instance, besides of providing the HDMI Ethernet channel, the Ethernet circuit 11 can also provide another Ethernet channel according to the IEEE 802.3 specification, which can establish another network connection to the network 16 (WAN or LAN) via an Ethernet interface 111 (for example, a RJ-45 interface). Please note, in the present invention, if the first HDMI device 10 or 20 has a built-in network unit for riding a foreign network (a WLAN for example) and capable of coupling with the Ethernet circuit 11, then the Ethernet circuit 11 can also use the built-in network unit and some appropriate network interfaces to make connection with the network 16. As soon as the Ethernet circuit 11 is connected to the network 16, the second HDMI device 13 can also establish connection with the network 16 through the HDMI channel provided by the HDMI interface 12. Therefore, by providing the present invention, the network 16 is feasible to both the first HDMI device 10 or 20 and the second HDMI device 13, and the advantages for the system with plural HDMI devices are obvious. For example, by given the first HDMI device 10 or 20 to be an HDMI receiving device (a TV for example), the second HDMI device 13 to be an HDMI sourcing device (a computer for example), and the network 16 to be an internet, then when an abnormal situation of the second HDMI device 13 being downloading video data from the internet 16 and the first HDMI device 10 or 20 being carelessly powered off is met, the internet connection can be still maintained for the Ethernet circuit 11 is still operated normally with the external power provided by the second HDMI device 13. Thus, the downloading in the second HDMI device 13 can be continuously executed with no need to re-establish any internet connection.

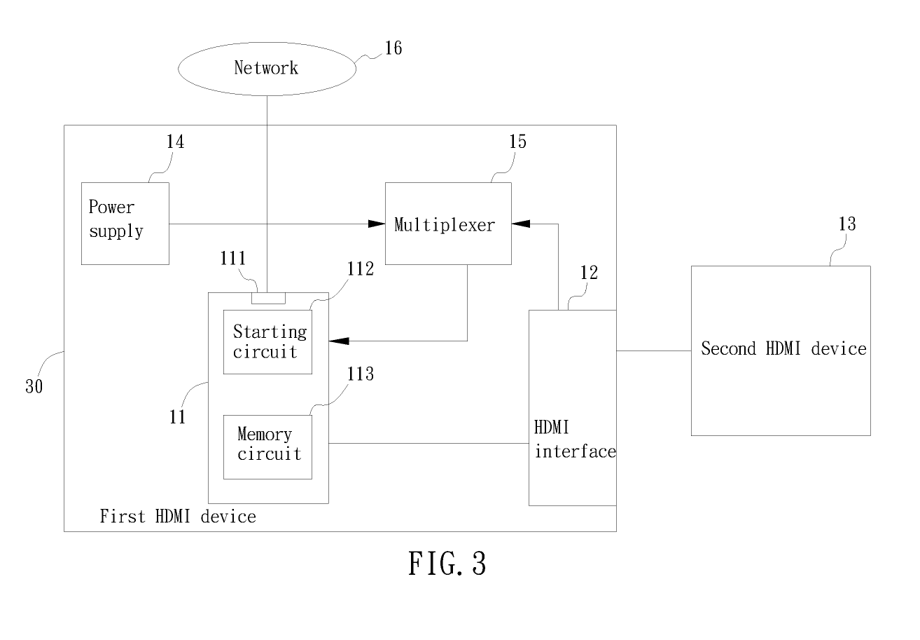

Referring now to FIG. 3, a further embodiment of the HDMI device is shown in a block diagram. In this HDMI device 30, the Ethernet circuit 11 can further comprise a starting circuit 112 and a memory circuit 113. The starting circuit 112 can perform a process of capability discovery and control (CDC) to actuate the HDMI Ethernet channel. The CDC process is well known to the art, and thus details thereabout are omitted herein. The memory circuit 113 can provide a physical address to the starting circuit 112. Then, the second HDMI device 13 can base on the physical address to locate and address the starting circuit 112 to further initiate the starting circuit 112 to perform the CDC process. Upon such an arrangement, the second HDMI device 13 can communicate with the first HDMI device 30 via the HDMI Ethernet channel. Preferably, the memory circuit 113 can be used to store an extended display identification data (EDID), which includes the physical address of the starting circuit 112. The second HDMI device 30 can obtain the physical address through a display data channel (DDC) of the HDMI interface 12.

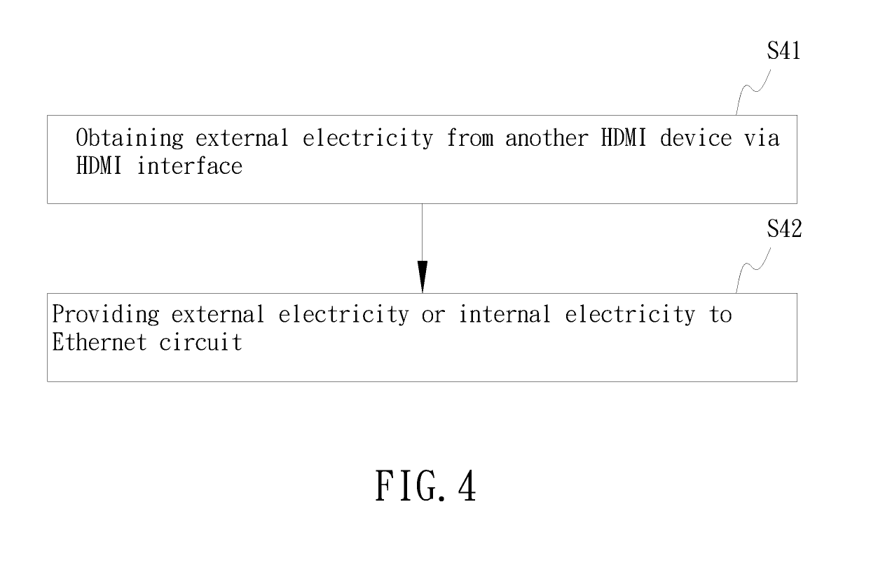

Referring now to FIG. 4, an embodiment of the power management method in accordance with the present invention is shown in a flowchart. The power management method is applicable to both the first HDMI devices 20 and 30. In Step S41, the first HDMI device 20 or 30 can be connected to another HDMI device (the second HDMI device 13 for example) for obtaining externally the required power via the HDMI interface 12. Typically, the external power can be obtained through the source port of the HDMI interface 12. In Step S42, provide one of the external power and the internal power (i.e. provided by the power supply 14) to the Ethernet circuit 11. In particular, when the internal power supply is off, the external power as a backup power is provided to the Ethernet circuit 11, according to Step S42.

By providing the HDMI device and the associated power management method for the same in accordance with the present invention to the HDMI Ethernet channel, the HDMI device can obtain the external power from another HDMI device as a backup power via the HDMI interface so as to normally operate the HDMI circuit at a power-off state of its own power supply. Upon such an arrangement, when the internal power meets any problem, the Ethernet circuit can still operate and thus can still perform network connection for another HDMI device to execute appropriate data transmission such as a video download from the network.

While the present invention has been particularly shown and described with reference to a preferred embodiment, it will be understood by those skilled in the art that various changes in form and detail may be without departing from the spirit and scope of the present invention.

What is claimed is:

1. An HDMI device, comprising:
an HDMI interface, comprising an HDMI Ethernet channel; and
an Ethernet circuit for actuating the HDMI Ethernet channel;
wherein the Ethernet circuit is to obtain an external power from another HDMI device via the HDMI interface.

2. The HDMI device according to claim 1, wherein the Ethernet circuit obtains the external power via a source port of the HDMI interface.

3. The HDMI device according to claim 1, further comprising:
a power supply provides an internal power; and
a multiplexer, coupled with the power supply, the HDMI interface and the Ethernet circuit, outputs the internal power or the external power to the Ethernet circuit.

4. The HDMI device according to claim 3, wherein the multiplexer outputs the external power to the Ethernet circuit in the case that the power supply is off.

5. The HDMI device according to claim 1, wherein the Ethernet circuit comprises an Ethernet interface for connecting to a network, and the another HDMI device is connected with the network via the HDMI Ethernet channel.

6. The HDMI device according to claim 5, wherein the HDMI device is an HDMI receiving device and the another HDMI device is an HDMI source device.

7. The HDMI device according to claim 1, wherein the Ethernet circuit further comprising:
a starting circuit for performing an CDC process to enable the HDMI Ethernet channel; and
a memory circuit for providing a physical address to the starting circuit;
wherein the another HDMI device bases on the physical address enables the starting circuit to perform the CDC process.

8. The HDMI device according to claim 7, wherein the memory circuit is to store an extended display identification data (EDID) including the physical address, and the another HDMI device is to obtain the physical address through a display data channel (DDC) of the HDMI interface.

9. A power management method for an HDMI device, the HDMI device having an HDMI interface, an internal power source and an Ethernet circuit, the HDMI interface further comprising a HDMI Ethernet channel, the power management method comprising the steps of:
(1) obtaining an external power from another HDMI device via the HDMI interface; and
(2) providing the external power or an internal power of the internal power source to the Ethernet circuit.

10. The power management method according to claim 9, wherein the step (1) is to obtain the external power through a source port of the HDMI interface.

11. The power management method according to claim 9, wherein the step (2) is to provide the external power to the Ethernet circuit in the case that the internal power source is off.
